(19) United States
(12) Patent Application Publication
(10) Pub. No.: US 2002/0046406 A1
(43) Pub. Date: Apr. 18, 2002

(54) On-demand data system

(76) Inventors: Majid Chelehmal, Broomfield, CO (US); Douglas Jones, Boulder, CO (US); Mukta Kar, Louisville, CO (US); William Kostka, Boulder, CO (US); Rouzbeh Yassini-Fard, Nashua, NH (US)

Correspondence Address: COCHRAN & COLLINS LLP, Suite 230, 3555 Stanford Rd., Fort Collins, CO, 80525, US

(21) Appl. No.: 09/832,750

(22) Filed: Apr. 10, 2001

Related U.S. Application Data
(60) Provisional application No. 60/241,396, filed on Oct. 18, 2000.

(51) Int. Cl. H04N 7/173; G06F 3/00; H04N 5/445; G06F 13/00; H04B 1/66; H04N 7/12; H04N 11/02; H04N 11/04

(52) U.S. Cl. 725/87; 725/109; 725/39; 375/240.01

(57) ABSTRACT

Disclosed is a system for allowing on-demand delivery of data, such as MPEG-2 compressed video data, to a subscriber from a content server. The system utilizes a managed IP network that is coupled to the one or more content servers that allows the content servers to deliver data such as video, audio, and textual data with a guaranteed quality of service that is at least as good as broadcast quality service. The managed IP network is connected to a head end or other local cable service provider where video is delivered locally to subscribers. The IP transport data is translated to MPEG transport data, multiplexed onto an MPEG transport system, digitally modulated onto an rf carrier and up-converted to a specific frequency channel. The signal is then applied to the cable for delivery to the subscriber. Upstream signaling occurs through a set top box or computer that is connected to the cable and subsequently to a digital modulator/demodulator and ISP to a managed IP network 66. Low band signals can also be transmitted from the content servers back to the set top box or computer indicating confirmation of an order. Also, control signals such as stop, rewind, fast-forward, and slow can be transmitted back to the content server to control the transmission of data from the content server to the subscriber.

### CROSS REFERENCE TO RELATED APPLICATIONS

This application claims the benefit of U.S. provisional application Ser. No. 60/241,396 filed Oct. 18, 2000 entitled “On-Demand Data System,” by Majid Chelehmal, Douglas Jones, Mukta Kar, William Kostka and Rouzbeth Yassini-Fard.

### BACKGROUND OF THE INVENTION

a. Field of Invention

The present invention pertains generally to digital networks and more specifically to a combined system using IP transports and MPEG-2 transports.

b. Description of the Background

On-demand systems that are capable of delivering video, audio, and other data on-demand over a cable system have been the desire of many cable operators for quite sometime. The technical difficulties of providing such a system have been substantial. For example, providing sufficient bandwidth to supply such services has presented many difficult problems. Latency and quality of service are associated problems. Further, the ability to provide access to large databases that can be made available from content providers has also posed many significant problems. For these reasons, it would be desirable to provide a video-on-demand system, or more generally, a data-on-demand system that allows a user to access large databases that can be made available from content providers and to display or otherwise make available selected video or other data according to a user's schedule. Further it would be desirable to provide a system that allows a user to access any large database in an on-demand fashion.

### SUMMARY OF THE INVENTION

The present invention overcomes the disadvantages and limitations of the prior art by providing an on-demand system that is capable of allowing a user to access large databases of one or more content providers to use such data according to a schedule selected by the user. Such data can comprise video data, audio data, textual data, or any other type of desired data.

The present invention may therefore comprise a method of using a managed network and a video cable system to deliver video data on-demand from a content provider to a cable system user comprising; providing a listing of video data that is available from the content provider for selection by the cable system user, using a first transport mechanism that is compatible with said managed network to transmit the video data through the managed network to a cable system provider in response to a request by the cable system user, converting said first transport mechanism to a second transport mechanism that is compatible with the video cable system, transmitting the video data to the user through the video cable system using the second transport mechanism.

The present invention may further comprise a method of translating a data stream suitable for transmission on an IP transport mechanism to a data stream suitable for transmission on an MPEG transport mechanism comprising; separating timing data contained in the IP transport mechanism from content data, converting the timing data to adaptation information, placing the adaptation information in adaptation fields of the MPEG transport mechanism, combining said adaptation fields with corresponding content data.

The present invention may further comprise a system for delivering video data on-demand from a content provider to a cable system user coupled to a cable system comprising; a content server that provides a listing of video data available from the content provider, a managed network coupled to the content server that is capable of transmitting the video data using a first transport mechanism upon receiving a request from said cable system user to produce a plurality of first transport data streams, a translator that translates the first transport data streams to a plurality of second transport data streams on a second transport mechanism that is compatible with the cable system.

The advantages of the present invention are that a user can access one or more large databases of information such as video data that the user can select and display, listen or otherwise use in accordance with the user's schedule. For example, the user may be able to select a particular movie and have that movie displayed immediately or at any desired start time. Further, the user may wish to listen to certain selections of music or other audio information which can be selected and listened to according to the user's schedule. Even further, the user may wish to access certain video games or other type of information that may be stored digitally by a content provider and that can be made available by selection according to the user's choice and schedule. In fact, any type of desired data can be accessed in an on-demand fashion for use by the user according to the user's schedule including any type of application programs.

### BRIEF DESCRIPTION OF THE DRAWINGS

FIG. 1 is a schematic illustration of a user's system that is employed in accordance with the present invention.

FIG. 2 is a schematic block diagram of the overall system of the present invention.

FIG. 3 is a schematic illustration of the data stream of the IP transport that is transmitted through the manage IP network.

FIG. 4 is a schematic illustration of the MPEG transport of the compressed video data stream.

FIG. 5 is a schematic illustration of the MPEG transport of the program table data.

FIG. 6 is a schematic flow diagram of the functions performed by the translator.

### DETAILED DESCRIPTION OF PREFERRED EMBODIMENT OF THE INVENTION

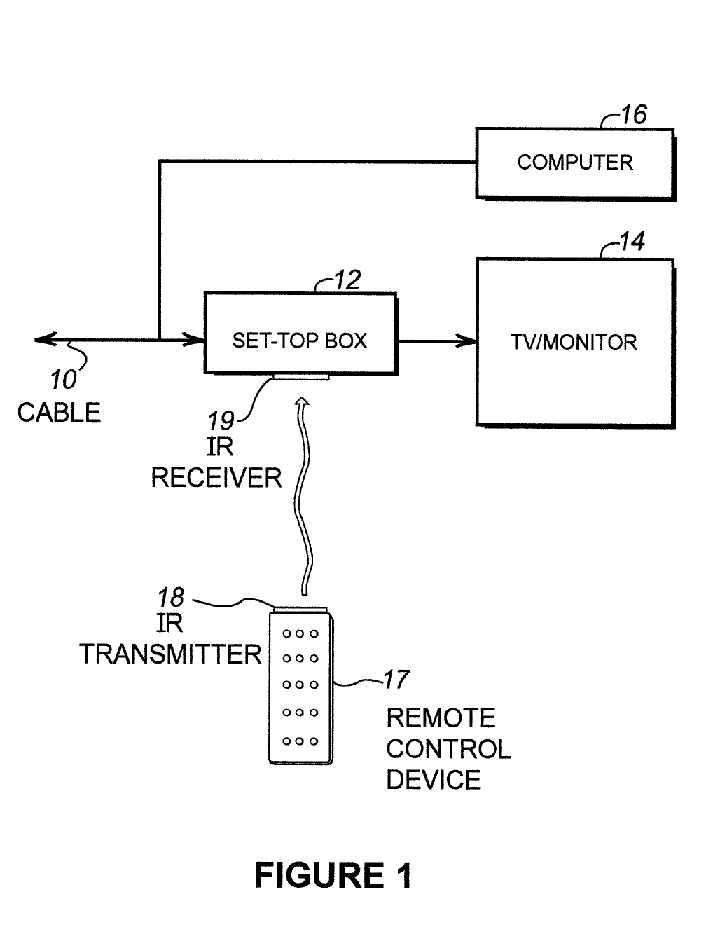

FIG. 1 is a schematic block diagram illustrating the portion of the system that is employed by the user of the present invention. As shown in FIG. 1, a cable 10 is deployed or otherwise made available in a location, such as the user's home, where the present invention may be used. Cable 10 can comprise any standard cable drop that is connected to an existing cable network such as the cable networks that are currently in widespread use. Cable 10 is capable of providing high bandwidth digital and analog signals. Cable 10 is connected to set top box 12 that is a microprocessor based system capable of performing various functions as disclosed below. Set top box 12 receives MPEG-2 transport data streams via the Cable 10. Content data such as movies and program information is supplied via the MPEG-2 transport data streams on cable 10 to set top box 12 as compressed MPEG-2 data. Set top box 12 is connected to TV/monitor 14 for display of video and textual data and presentation of audio data. The set top box decodes information provided on the cable and converts the data to analog data for display and presentation on an analog TV/monitor 14. The set top box that is utilized in accordance with the present invention, therefore, can constitute the standard set top box that is currently in use for digital cable systems. Billing systems used in conjunction with the set top box can also be used in a similar fashion with the present invention.

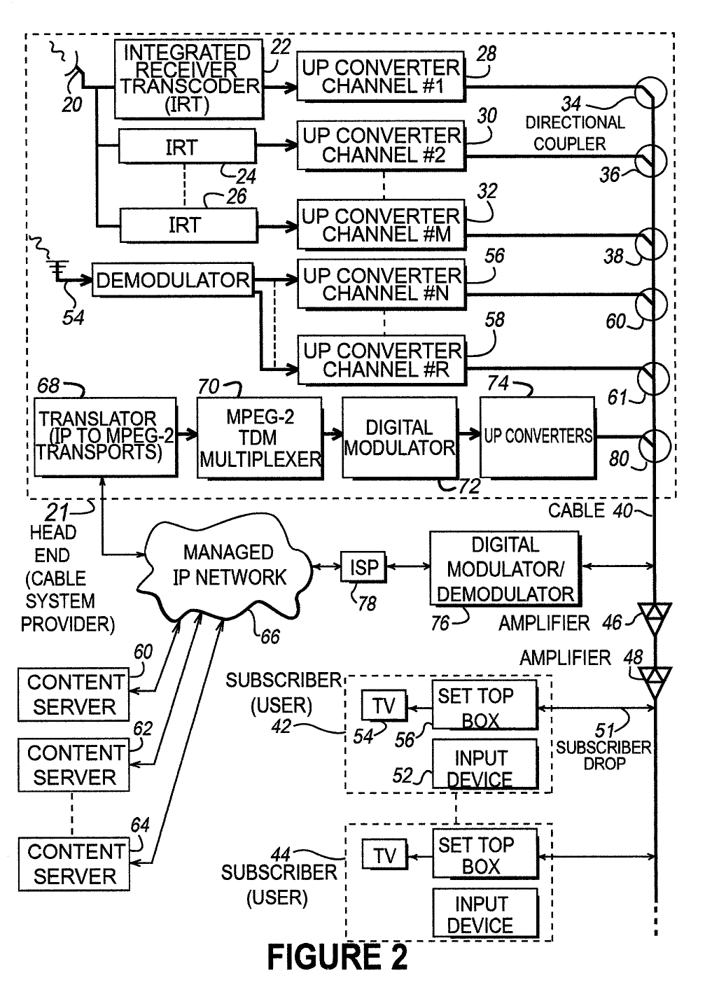

FIG. 2 is schematic block diagram of the system embodying the present invention. As shown in FIG. 2, antenna 20 receives digitally modulated rf signals. These signals may be transmitted by satellite, microwave link, or other means. A series of integrated receiver transcoders (IRTs) 22, 24, 26 demodulate the signals, decode the signals, and identify individual data packets according to ID numbers on the packets so that they can be separated into individual channels. For example, each IRT 22, 24, 26 has an associated data stream with corresponding packet IDs that it recognizes and decodes. Each of the data streams is then up-converted to a different frequency channel by up-converters 28, 30, 32. Each of the up-converted signals is then applied to directional couplers 34, 36, 38 for coupling onto the cable 40. The cable 40 is then distributed to numerous subscribers such as subscribers 43, 44. Numerous amplifiers exist throughout the cable system 40, such as amplifiers 46, 48. Each of the subscribers that subscribes to digital TV has a set top box such as set top box 50 of subscriber 42. Using an input device 52, the subscriber can operate the set top box 50 to select any one of a number of channels that are provided on the cable 40. The set top box also functions as a digital to analog converter to convert the digital contents of the signals to an analog signal for display on the analog TV/monitor 54. If TV 54 is a digital TV/monitor, the set top box can transmit the digital signal for display on the digital TV. Input device 52 can comprise a standard remote control device that uses ir signals to control the TV/monitor 54.

As also shown in FIG. 2, each of the set top boxes, such as set top box 50, is provided with a key that is capable of decoding various channels that are provided on the cable 40. For example, a subscriber may only subscribe to a basic channel subscription package that does not include any premium channels. In that case, a subscriber 42 would have a set top box 50 that is supplied with a decoding key that is only capable of decoding the channels that are provided on cable 40 that correspond to the basic cable subscription. Likewise, a subscriber that subscribes to the highest grade of cable package is provided with a key that is capable of decoding all of the channels except for the pay-per-view channels.

As FIG. 2 also illustrates, a number of channels are dedicated to pay-per-view in accordance with standard digital cable TV programming. If a subscriber would like to view a pay-per-view channel, the subscriber would normally call the head end 21 and place an order for pay-per-view. The subscriber identifies himself by the address or telephone number that is cross-linked by the head end to an ID number for a particular set top box for that particular subscriber. The head end then transmits a key to the set top box of the subscriber so that the subscriber can view the particular pay-per-view broadcast. Alternatively, the subscriber can simply select a pay-per-view program from a program listing. The set top box then sends the request back to the head end. The head end transmits a key, in the same fashion, to the set top box that has placed the order. The pay-per-view is then set for a showing at a particular time and is broadcast to all subscribers. The subscribers having the key to decode the pay-per-view broadcast can then view that particular pay-per-view broadcast on the designated channel at the time it is broadcast. The requests for on-demand data operate in a similar fashion and can use the standard billing processes that are currently in place for the pay-per-view system.

Referring again to FIG. 2, head end device 21 may also program the cable 40 with analog broadcast signals. As shown in FIG. 2, this may typically occur by the head end device utilizing an antenna 54 that receives standard broadcast signals over the airways. For example, these may be standard broadcast signals from ABC, NBC, CBS, UPN, Fox, PBS, etc. Each of these analog signals may then be up-converted and assigned a separate channel as shown by up-converters 56, 58. Head end 21 then places these analog signals on the cable 40 using directional couplers 60 and 61.

Currently, most cable companies offer both digital and analog service. In that regard, content received by the IRTs 22, 24, 26 may also be converted to analog signals and placed on the cable 40. Similarly, the content received by antenna 54 may also be included in the downlink transmission that is received by antenna 20 so that antenna 54 and the associated up-converters 56, 58 can be eliminated.

The video-on-demand, or in general, the data-on-demand system of the present invention, in comparison to pay-per-view, or similar systems, allows a user to access large databases having a great deal of content at the convenience of the user. The user can select content from content providers for delivery to the user at a time that is desirable for the user which does not correspond to a pre-planned broadcast time. Content servers 60, 62, 64 can comprise any number of different servers that have access to very large databases with a large amount of content. For example, Turner Broadcasting may own the rights to display thousands of movies that are stored in a database and accessible through a content server that is operated by Turner Broadcasting. Each of these content servers 60, 62, 64 is connected to a managed IP network 66. The managed IP network 66 provides a guaranteed quality of service by managing various layers of protocol of the network 66. In essence, the managed IP network 66 provides a virtual dedicated line in the network to guarantee delivery of data packets in a fashion that provides the required quality of service. The managed IP network 66 uses real time protocol (RTP), user datagram protocol (UDP) and internet protocol (IP) to ensure that data packets are transmitted from the content servers 60, 62 and 64 to translator 68 so they can be decoded as an uninterrupted stream.

Referring again to FIG. 2, data from the content servers 60-64 is provided to subscribers such as subscribers 42, 44 through the managed IP network 66 which transmits the data through the head end back to the subscriber. The managed IP network 66 is capable of providing the data of the content servers in a managed real time fashion with a guaranteed quality of service. The present invention, translates data from an IP transport system, such as used by the managed IP network, into a MPEG transport system for transmission from the head end (cable system provider) 21 to a cable subscriber over cable 40. In that fashion, the data is provided to the subscriber as standard MPEG-2 compressed data packets and can be delivered using the standard MPEG transport system of head end 21, in the same fashion as the other video data is delivered to the subscriber from the head end.

The manner in which data is provided from content servers 60, 62, 64 at the request of the cable user in an on-demand fashion is described as follows. When a content server such as content server 60 receives a request (as described below) for a particular data file, such as a particular movie, the content server 60 begins the transfer of that data to the managed IP network 66 as compressed MPEG-2 video data using an IP transport mechanism. The managed IP network 66 is capable of transferring the data through the managed IP network 66 using RTP, UDP, and IP protocols, as set forth above. This allows the data to be transferred through the managed IP network 66 with a guaranteed quality of service which is at least sufficient to allow broadcast quality video to be transmitted to the head end 21.

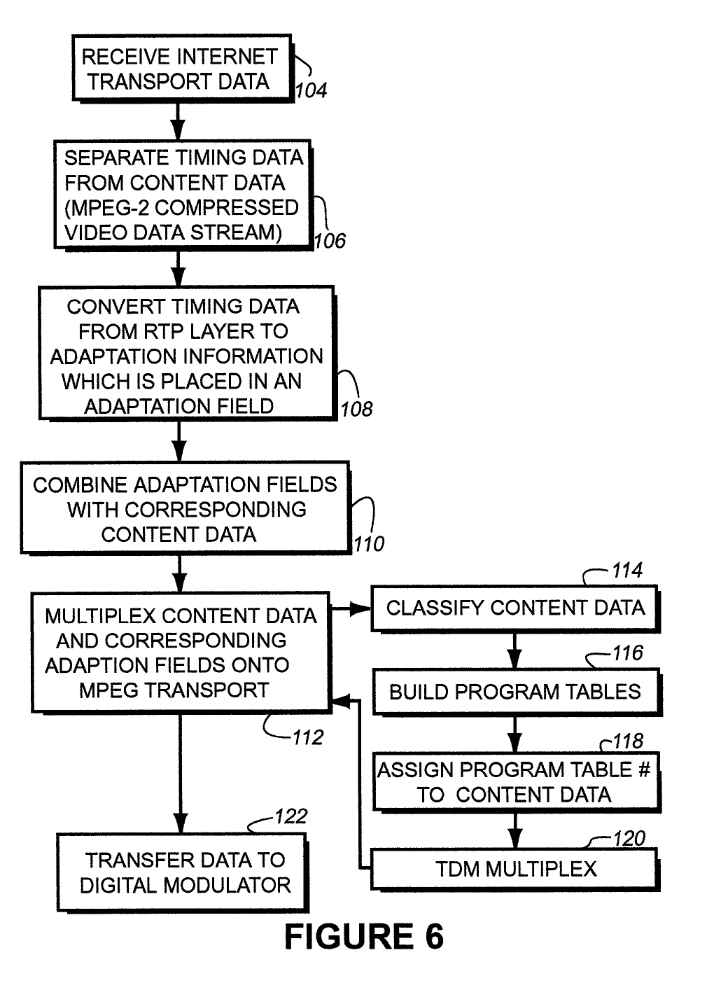

The translator 68, of FIG. 2, translates the timing information of the IP transport into adaptation information for the MPEG transport. The steps performed by the translator 68 are disclosed in FIG. 6. The translated data is then delivered to the MPEG-2 TDM multiplexer 70 that multiplexes the data streams from the translator 68, that include the content data streams and adaptation fields, to generate a standard MPEG-2 TDM multiplexed signal. The content data of the IP transport stream is available at the head end 21 with the timing information that is extracted from the RTP layer, as disclosed below. The timing information and content data is reconstructed into a MPEG-2 program stream with adaptation fields to maintain the plesioisochronous delivery and synchronization between the content data. The content data for a particular program stream, such as a movie that has been ordered by a subscriber, is multiplexed by the MPEG-2 TDM multiplexer 70 with other content data that has, perhaps, been ordered by one or more additional subscribers. The MPEG-2 TDM multiplexer 70 uses statistical multiplexing techniques that optimize program delivery rates on a per channel basis.

As further shown in FIG. 2, the signal is then transmitted to a digital modulator 72 that digitally modulates the multiplexed signal onto a radio frequency (rf) carrier. When the digital modulator 72 digitally modulates the TDM multiplexed digital signals onto an rf carrier, the digital modulator 72 uses well known digital modulation techniques such as QAM-64 or QAM-256. Of course, any type of desired digital modulation technique can be used. The digitally modulated rf carrier is then up-converted by up-converters 74 to a particular frequency channel. The up-converted signal is transmitted to directional link 80 that places the MPEG transport data stream on the cable 40. The head end device 21 transmits a decoding key to the set top box 50 using the identification number of the set top box 50. Set top box uses this decoding key to decode the digital data that has been encoded using that key. This procedure may use the standard encoding/decoding (encryption/description) and billing structure that is currently used between the head end 21 and the set top box 50 for standard pay-for-view processes that are currently in use. The subscriber, such as subscriber 42, then selects the particular frequency channel on set top box 50 using the input device 52 to view the movie that the subscriber has ordered. As indicated above, the multiplexer 70 can multiplex a number of different signals (programs) on a single data stream that is up-converted to a single frequency channel. MPEG-2 allows as much as 10 to 12 different programs to be multiplexed onto a single data stream. Hence, 10 to 12 different subscribers could tune to a single frequency channel and each decode a different program with a different decoding key that has been delivered to that subscriber in accordance with the particular program that subscriber has ordered.

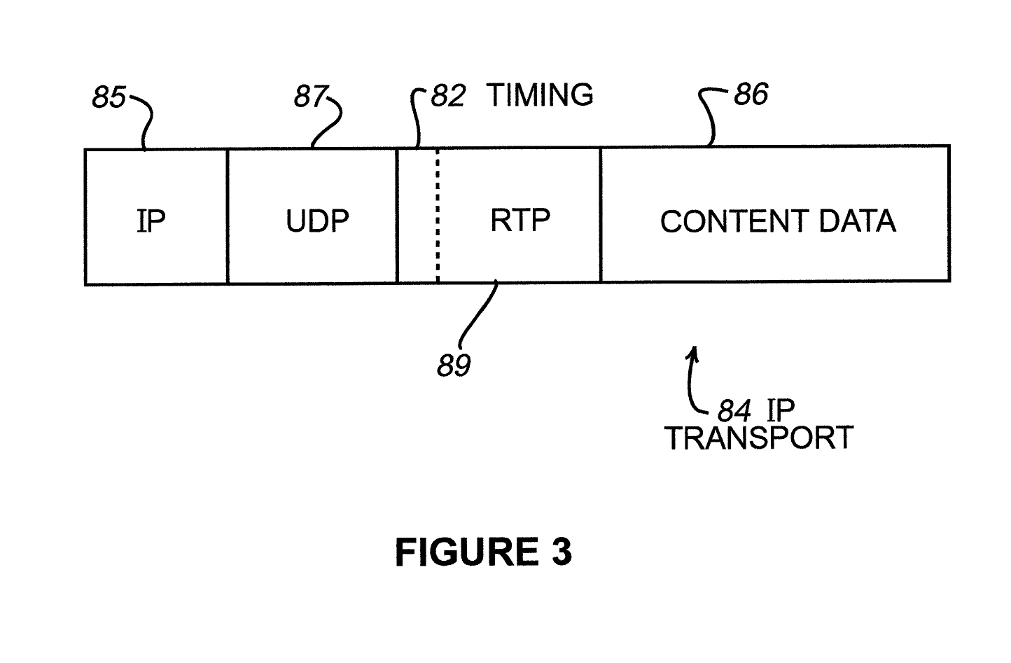

As shown in FIG. 3, the timing information 82 constitutes part of the real time protocol (RTP) portion of the IP transport 84. The RTP, UDP and IP layers of protocol constitute the portions of the transport mechanism that allow the MPEG-2 compressed video data stream 86 to be transmitted through the IP managed network 60 with a guaranteed quality of service. The RTP layer 89 is a protocol that rides on top of the UDP layer 87, which in turn rides on top of the IP layer 85. The IP layer 85 is the transport protocol, while UDP layer 87 is a signaling mechanism, and RTP layer 89 is the real time protocol layer. The RTP layer 89 includes the critical timing information 82 that relates to how to deliver a particular set of bits of the content data. The IP layer 85 is the layer that actually gets managed with regard to routing the data streams through the managed network 66. The latencies that are generally associated with routing are then managed through the IP transport layer 85 so that the data can actually be passed through the network with the guaranteed level of service, as indicated above. The managed IP network 66 makes dynamic routing decisions that essentially result in one or more dynamic reserved pathways for the transmission of data, that are equivalent to a virtual dedicated line. These mechanisms for transmitting data through a managed IP network, such as IP managed network 66, are known to those skilled in the art.

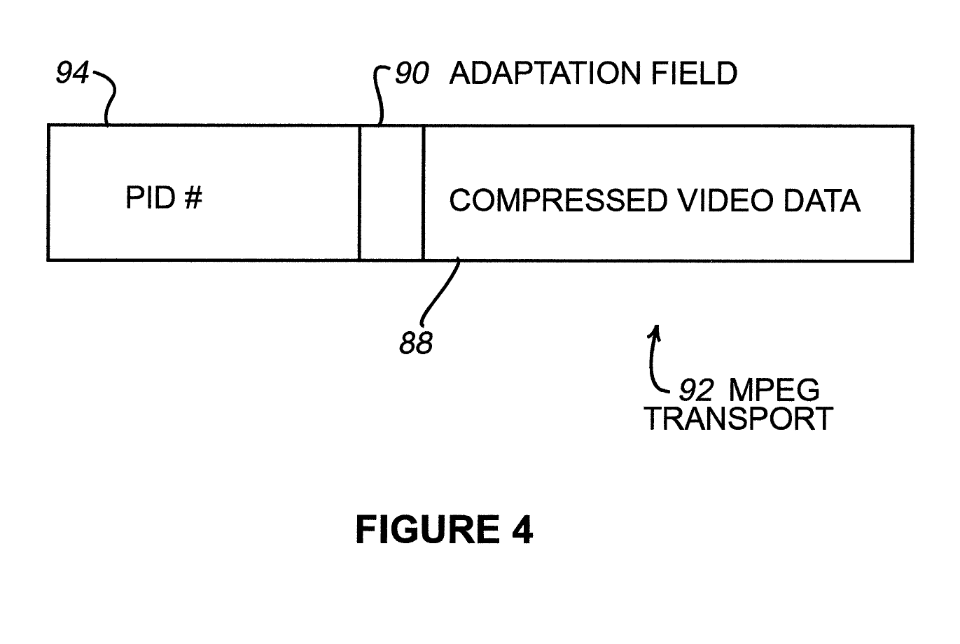

FIG. 4 is a schematic illustration of the data structure of the MPEG-2 transport data stream that is generated at the output of the translator 68. As shown in FIG. 4, the MPEG-2 compressed video data stream 88 corresponds to the content data 86 of FIG. 3. In other words, the content data 86 may comprise the MPEG-2 compressed video data for a movie. For example, the content data can be a MPEG-2 compressed video data stream 88, as illustrated in FIG. 4, or it can be an audio data stream in English, an audio data stream in German, or some other language. The content data can also be textual data in a particular language. An adaptation field 90 is also provided for the MPEG transport 92. The adaptation field 90 includes the timing information that has been translated from the timing information 82 of the IP transport 84 of FIG. 3. As shown in FIG. 4, a PID number 94 is also provided as part of the MPEG transport 92. The PID number is an identification number to identify the MPEG-2 compressed video data stream 88 that is part of the MPEG transport 92.

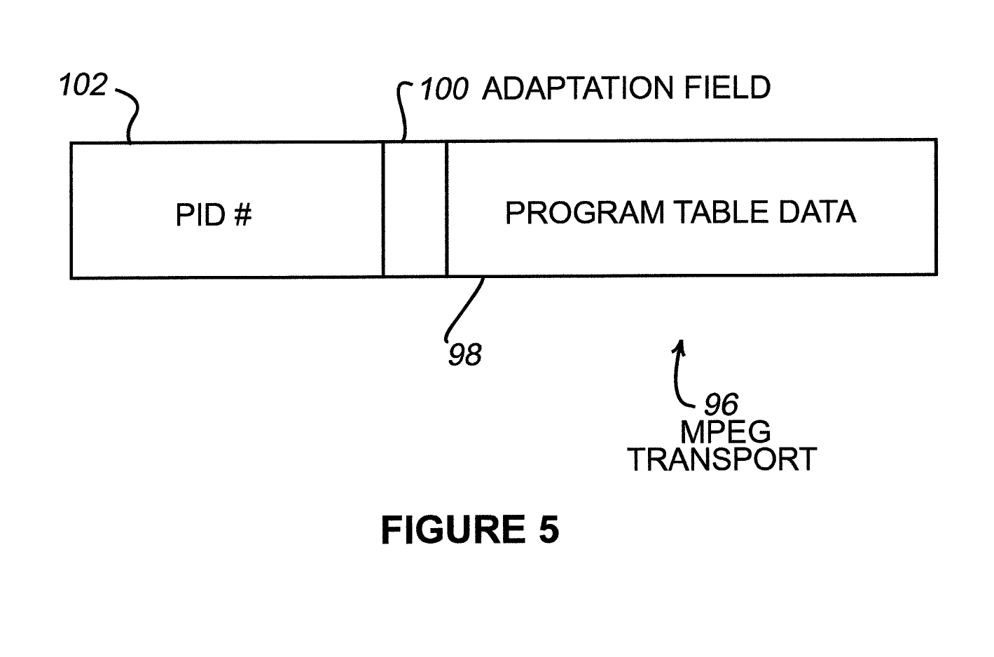

FIG. 5 discloses a similar MPEG transport 96. The program table content data of the MPEG transport 96 also includes a program identifier (PID) number 102 and an adaptation field 100, in the same manner as MPEG transport 92. The content data that is part of the MPEG transport 96 is a program table that is a table of the program identifiers (PIDs) that associate the program identifiers with a particular set of data for a particular program. If a particular movie is selected by a user with an English sound track, the program table data 98 provides a listing of the program identifiers that can be selected from the MPEG transport 92 to view that movie with an English audio version sound track. In other words, the program table associates the proper set of PIDs for that particular movie in English. The program table data 98 essentially allows the TDM multiplexed content data streams to be identified by providing a table of PID numbers for any selected program. Hence, if a user wants to select a particular program, the user would go to the program table data 98 and select the PID numbers for the desired program. The program table then provides the proper series of PID numbers. PID extractors are then used to extract the proper set of data streams. The PID numbers are assigned by multiplexer 70 during the multiplexing process. Multiplexer 70 builds the program table according to information relating to the content of the data stream provided by the translator 68. The structures for the data shown in both FIGS. 4 and 5 constitute the well known structures that are part of the MPEG transport standards and are commonly used with the transmission of MPEG compressed video data.

FIG. 6 is a schematic flow diagram of the steps that are performed by the translator 68. At step 104, the translator 68 receives the internet transport data 84, such as shown in FIG. 3. At step 106 of FIG. 6, each of the RTP 89, UDP 87, and IP 85 layers are stripped off of the program elementary stream and repackaged as a MPEG transport stream 92, 96, such as shown in FIGS. 4 and 5. At step 106, the critical timing data 82 (FIG. 3) is extracted from the RTP layer 89 and used to create an adaptation field 90 (FIG. 4) that contains timing information for the MPEG transport 92. There are typically multiple RTP headers 89 inside of each of the UDP packets 87. There is one RTP header associated with each program elementary data stream, such as content data 86, which can comprise data relating to audio, video, or text. As indicated above, there also may be many different audio streams, such as audio streams for different languages, as well as many different text streams that are associated with a single video stream. At step 108, the timing information from the RTP layer is converted from the RTP format into adaptation information which is placed in the adaptation field 40 (FIG. 4). The adaptation field is then be reassembled with the corresponding program elementary stream at step 110.

As also shown in FIG. 6, the content data and adaptation fields are multiplexed onto a MPEG transport at step 112. This involves several substeps 114, 116, 118, 120. At step 114, the translator 68 identifies the content of the program elementary stream to classify it. For example, the program elementary stream, as indicated above, can comprise compressed video, audio, or textual data. Further, each of these streams can be further classified into audio data of a certain language or textual data of a certain language. Each of these streams is associated with a given video program, as indicated above in the program table. For example, all of the German audio data may be associated together with a particular set of MPEG-2 compressed video data. At step 116, the multiplexer 70 (FIG. 2) builds program tables such as program table 98 of FIG. 5 that associates each of these data streams, as indicated above, based on the content information provided by the translator 68. Program identifier numbers (PIDs) are assigned to the content data at step 118 in accordance with the program table data information. The multiplexer 70 then generates a time domain multiplexed (TDM) signal of the various data streams illustrated in FIGS. 4 and 5 at step 120. The TDM multiplexed data streams are then passed to the digital modulator 72 (FIG. 2) at step 122 of FIG. 6.

The process of viewing and selecting a data set such as the listing of movies from content servers 60-64 is described below. Any particular content server such as content server 60 (FIG. 2) can arrange with the head end 21 to generally broadcast a listing of the content that is available from that particular server on a designated channel using the communication network that includes the managed IP network 66, the translator 68, the multiplexer 70, the digital modulator 72, and up-converter 74. Similarly, the content can be placed on a channel using the satellite downlink process using satellite receiver 20, an IRT, and up-converter to place this information on a particular channel. Alternatively, a user can access this information through an ISP 78 that is connected to managed IP network 66. In this mode of operation, the subscriber 42 utilizes the input device 52 to activate the set top box 50 to send a request to a particular content server, such as content server 60, to request a listing of the content data available from content server 60. Set top box 50 generates this request which is transmitted over the subscriber drop 51 to amplifier 48 and amplifier 46 to a digital modulator/demodulator 76. The digital modulator/demodulator 76 demodulates the rf signal from the cable 40 to produce a digital signal that is transported to an ISP 78. The modulator/demodulator 76 comprises a combination of devices that receive the information from the set-top box 50 in a prescribed format and translate this information to another prescribed format or formats as necessary. For example, in the DOCSIS specification the modulator/demodulator 76 includes a CMTS which receives the upstream data burst and forwards that information to itself for control or to the network, as appropriate, based on the information in the burst. There are similar devices in the DVB/Davic environment. A typical CMTS device may be the uBR 7246 universal broadband router available from Cisco Systems. The ISP 78 routes the signal to the managed IP network 66 and to the appropriate content server 60 using an IP address for the content server 60.

The content server 60 receives the request from the set top box 50 that has an assigned IP address, in most cases, and provides a listing of requested content information from the subscriber 42. The information provided by the content server is sent to the managed IP network 66 with the IP address that is assigned to the set top box 50. The ISP 78, which can be a cable operator, receives the IP signal from the managed IP network 66 and transmits this to a digital modulator/demodulator 76 where the digital signal from the ISP is modulated and sent to cable 40. The modulated signal is transmitted on the cable 40 through amplifier 46 and amplifier 48 to the set top box 50 via the subscriber drop 51. Set top box 50 then displays the content information on TV/monitor 54 or computer 16 (FIG. 1).

The set-top box 50 can be provisioned to have a IP address via several mechanisms. Advanced set-top boxes currently use a combination of techniques referred to as in-band and out-of-band transmissions based upon whether the provisioning information comes embedded in the program channel (in-band) or in a separate signaling channel (out-of-band). It does not matter whether the provisioning information that is sent on the cable data stream is MPEG defined. Within an MPEG stream, data may be embedded using MPEG defined constructs, or may be embedded as IP packets using DOCSIS constructs. It is also possible for the out-of-band transmissions of provisioning information to use either MPEG transports for native or DOCSIS transmissions, or it can use a DVB/Davic ATM transport stream. All of these formats can exist concurrently on the cable 40 in addition to the normal analog NTSC video channels. In other words, the cable 40 is not restrictive with regards to its transport capabilities.

Some systems exist that transmit all of the data to the set-top box via in-band signaling. For example, satellite set-top boxes operate in this fashion. However, using cable, the current best practice is to utilize out-of-band signaling because of the immediate, unswitched, link to the set-top box. In-band transmissions are only valid when the subscriber is tuned to an in-band channel carrying the data. Hence, data cannot be received by the set-top box without the cooperation of the subscriber in tuning to a particular band.

The subscriber 42 can select a particular content program such as a movie by using the input device 52 (or a mouse connected to computer 16) to manipulate the set top box 50 to identify the particular movie or other data that the subscriber 42 desires. This request is then sent through the cable 40 to the digital modulator/demodulator 76, the ISP 78, the managed IP network 66 to the particular content server such as content server 60. The request may indicate the time at which the data is requested and indicates the ID number of the set top box 50. The content server 60 then sends a signal to the set top box 50 through the same path in reverse confirming the request, indicating the time the information will be sent, the charges that will be billed to the subscriber 42 and the channel on which the data will be sent to the set top box 50. In addition, the content server will provide all of the information so that the set top box 50 can locate and decode the digital stream to obtain the content information for display on the TV/monitor 54. The program information is sent in a rigid, standard-defined format to enable the set-top box to decode the information in a standard form. Silicon providers for set-top boxes create ICs that decode the standards-based MPEG streams. These ICs are capable of reading the program tables and decoding the information. Additionally, the set top box 50 can respond to the input device 52 to send signals to the content server 60 to pause, rewind, fast-forward, slow, or other functions that are desired by the subscriber to be performed by the content server.

The present invention therefore provides a system for delivering digital video and audio programs using a combination of a highly efficient MPEG-2 transport that can deliver compressed MPEG-2 data together with an IP delivery system that links one or more content servers to a MPEG-2 local delivery system such as a head end. This system exploits the strengths of both the MPEG and IP systems using standard based techniques employing IETF RFC protocols and QoS protocols such as RSVP, and is fully compatible with open standard protocols such as DOCSIS. The system is implemented using a digital set top box that is connected either with or without a high-speed upstream data connection since only signaling information is transmitted upstream. Program information such as compressed MPEG-2 video data is transmitted downstream over the high bandwidth cable either in-band or out-of-band. This system uses end-to-end encrypted delivery systems to secure ordering information as well as content information. Proprietary interactive systems can also utilize the architecture of the present invention. In this fashion, on-demand data can be provided to a user through a set top box to a TV or computer system that allows the user to access this data at a time and location that is convenient for the user.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of using a managed network and a video cable system to deliver video data on-demand from a content provider to a cable system user comprising:
providing a listing of video data that is available from said content provider for selection by said cable system user;
using a first transport mechanism that is compatible with said managed network to transmit said video data through said managed network to a cable system provider in response to a request by said cable system user;
converting said first transport mechanism to a second transport mechanism that is compatible with said video cable system;
transmitting said video data to said user through said video cable system using said second transport mechanism.

2. The method of claim 1 where said step of providing a list of video data further comprises:
generating a request for said listing of video data that is transmitted from said cable system user through said cable to an internet service provider that is connected to said managed network;
providing said listing of video data that is available from said content provider that is transmitted from said content provider through said managed network, said internet service provider and said cable to said provider.

3. The method of claim 2 further comprising generating a request for a particular video data stream that is transmitted from said cable system user through said cable to an internet service provider that is connected to said managed network and said cable.

4. The method of claim 3 further comprising generating a confirmation signal and decoding information that is transmitted from said content provider to said cable system user through said managed network and said internet service provider to said cable.

5. The method of claim 1 wherein said act of using a first transport mechanism to transmit said video data through said managed network to a cable system provider further comprises:
using real time protocol as a transport mechanism in an IP managed network to transmit said video data through said IP managed network with at least a predetermined level of quality of service.

6. The method of claim 1 wherein converting said first transport mechanism to a Second transport mechanism comprises:
converting an IP transport mechanism to an MPEG transport mechanism.

7. The method of claim 5 wherein converting said first transport mechanism to a second transport mechanism comprises;
converting an IP transport mechanism to an MPEG transport mechanism.

8. The method of claim 7 wherein converting said IP transport mechanism to an MPEG transport mechanism further comprises:
separating timing data contained in said real time protocol from content data;
converting said timing data to adaptation information;
placing said adaptation information in adaptation fields of said MPEG transport mechanism;
combining said adaptation fields with corresponding content data.

9. The method of claim 8 further comprising:
multiplexing said adaptation fields and said content dates on to said MPEG transport to generate an MPEG transport data stream;
digitally modulating said MPEG transport data stream to create a digitally modulated MPEG transport data stream;
up-converting said digitally modulated MPEG transport data stream to a selected frequency channel for transmission on said cable system.

10. A method of translating a data stream suitable for transmission on an IP Transport mechanism to a data stream suitable for transmission on an MPEG transport mechanism comprising:
separating timing data contained in said IP transport mechanism from content data;
converting said timing data to adaptation information;
placing said adaptation information in adaptation fields of said MPEG transport mechanism;
combining said adaptation fields with corresponding content data.

11. The method of claim 10 further comprising:
multiplexing said adaptation fields and said content data onto said MPEG transport mechanism.

12. A system for delivering video data on-demand from a content provider to a cable system user coupled to a cable system comprising;
a content server that provides a listing of video data available from said content provider;
a managed network coupled to said content server that is capable of transmitting said video data using a first transport mechanism upon receiving a request from said cable system user to produce a plurality of first transport data streams;
a translator that translates said first transport data streams to a plurality of second transport data streams on a second transport mechanism that is compatible with said cable system.

13. The system of claim 12 wherein said first transport mechanism is an IP transport mechanism and said second transport mechanism is an MPEG transport mechanism.

14. The system of claim 12 further comprising:
multiplexer that multiplexes said second transport data streams onto said second transport mechanism.

15. The system of claim 14 further comprising:
digital modulator that digitally modulates said second transport data streams, that have been multiplexed onto said second transport mechanism, onto an rf carrier signal.

16. The system of claim 15 further comprising:
up-converting said rf carrier signal that has been digitally modulated to a predetermined frequency channel or said cable system.

17. A method of delivering data on-demand from a content provider in response to a request from a user comprising:
transmitting said data from said content provider to a managed IP network;
transmitting said data on an IP transport on said managed IP network with a predetermined quality of service to a cable service provider that is coupled to a plurality of cable users on a cable system;
converting said data on said IP transport to an MPEG transport that is compatible with said cable system.
